(19) United States
(12) Patent Application Publication
(10) Pub. No.: US 2017/0295113 A1
(43) Pub. Date: Oct. 12, 2017

(54) LONGEST QUEUE IDENTIFICATION

(71) Applicants: Andrea Francini, Chapel Hill, NC (US); Wolfram Lautenschlaeger, Sachsenheim (DE)

(72) Inventors: Andrea Francini, Chapel Hill, NC (US); Wolfram Lautenschlaeger, Sachsenheim (DE)

(73) Assignees: Alcatel-Lucent USA Inc., Murray Hill, NJ (US); Alcatel Lucent, Boulogne-Billancourt (FR)

(21) Appl. No.: 15/091,890

(22) Filed: Apr. 6, 2016

(51) Int. Cl. H04L 12/861; H04L 12/863

(52) U.S. Cl. CPC H04L 49/90; H04L 47/622

(57) ABSTRACT

The present disclosure generally discloses a longest queue identification mechanism. The longest queue identification mechanism, for a set of queues of a buffer, may be configured to identify the longest queue of the set of queues and determine a length of the longest queue of the set of queues. The longest queue identification mechanism may be configured to identify the longest queue of the set of queues using only two variables including a longest queue identifier (LQID) variable for the identity of the longest queue and a longest queue length (LQL) variable for the length of the longest queue. It is noted that the identity of the longest queue of the set of queues may be an estimate of the identity of the longest queue and, similarly, that the length of the longest queue of the set of queues may be an estimate of the length of the longest queue.

### TECHNICAL FIELD

The disclosure relates generally to the technical field of communication networks and, more particularly but not exclusively, to management of packet buffers in packet-switched communication networks.

### BACKGROUND

In communication networks, buffers are used in various contexts and for various purposes. It is common for a buffer to be divided into a set of queues and to include a buffer manager to manage queuing of packets in the set of queues of the buffer. The buffer manager typically performs buffer management actions, which typically include determining when a packet should be dropped instead of being assigned space in the buffer and identifying the packet that should be dropped when a packet drop decision is made. When multiple packet queues are present in the same buffer, a packet scheduler manages the distribution of service to the multiple queues, where a service typically includes extraction of a packet from a queue (typically from the head of the queue) for subsequent transfer of the packet. There are many types of packet scheduling algorithms and buffer management schemes which may be used to manage the admission of packets to the multiple queues of a buffer and extraction of packets from the multiple queues of the buffer. As a result, many different combinations of packet scheduling algorithms and buffer management schemes also exist. For example, some combinations of packet scheduling and buffer management schemes include round robin with longest queue first (RR/LQF) which is a top-performing matching algorithm for input-queued packet switches, stochastic fairness queuing (SFQ) which is a buffer management scheme that combines per-flow queues with a work-conserving round-robin scheduler, and so forth. These and other combinations of packet scheduling and buffer management schemes rely on identification of the longest queue of the buffer, which may be performed in various ways.

### SUMMARY

The present disclosure generally discloses a mechanism for identifying a longest queue of a set of queues of a buffer.

In at least some embodiments, an apparatus includes a processor and a memory communicatively connected to the processor. The processor is configured to determine an updated selected queue length of a selected queue based on updating of a selected queue length of the selected queue based on a packet event. The processor is configured to determine whether a longest queue identifier and a selected queue identifier of the selected queue match. The processor is configured to, based on a determination that the longest queue identifier and the selected queue identifier of the selected queue do not match, determine whether the updated selected queue length of the selected queue is greater than a longest queue length and determine, based on whether the updated selected queue length of the selected queue is greater than the longest queue length, whether to update the longest queue identifier and the longest queue length.

In at least some embodiments, a method includes determining an updated selected queue length of a selected queue based on updating of a selected queue length of the selected queue based on a packet event, determining whether a longest queue identifier and a selected queue identifier of the selected queue match, and, based on a determination that the longest queue identifier and the selected queue identifier of the selected queue do not match, determining whether the updated selected queue length of the selected queue is greater than a longest queue length and determining, based on whether the updated selected queue length of the selected queue is greater than the longest queue length, whether to update the longest queue identifier and the longest queue length.

In at least some embodiments, an apparatus includes a processor and a memory communicatively connected to the processor. The processor is configured to determine an updated selected queue length of a selected queue based on updating of a selected queue length of the selected queue based on a packet event. The processor is configured to determine whether the updated selected queue length of the selected queue is greater than a longest queue length. The processor is configured to, based on a determination that the updated selected queue length of the selected queue is greater than the longest queue length, set a longest queue identifier to a selected queue identifier of the selected queue and set the longest queue length to the updated selected queue length of the selected queue.

In at least some embodiments, a method includes determining an updated selected queue length of a selected queue based on updating of a selected queue length of the selected queue based on a packet event, determining whether the updated selected queue length of the selected queue is greater than a longest queue length, and, based on a determination that the updated selected queue length of the selected queue is greater than the longest queue length, setting a longest queue identifier to a selected queue identifier of the selected queue and setting the longest queue length to the updated selected queue length of the selected queue.

### BRIEF DESCRIPTION OF THE DRAWINGS

The teachings herein can be readily understood by considering the following detailed description in conjunction with the accompanying drawings, in which:

FIG. 1 depicts a communication device including a buffer having a set of queues configured to queue packets traversing the communication device and a buffer manager configured to manage the set of queues;

FIG. 2 depicts an exemplary method for identifying the longest queue of a set of queues of a buffer;

FIG. 3 depicts an exemplary method for identifying the longest queue of a set of queues of a buffer; and

FIG. 4 depicts a high-level block diagram of a computer suitable for use in performing various functions described herein.

To facilitate understanding, identical reference numerals have been used, where possible, to designate identical elements that are common to the figures.

### DETAILED DESCRIPTION

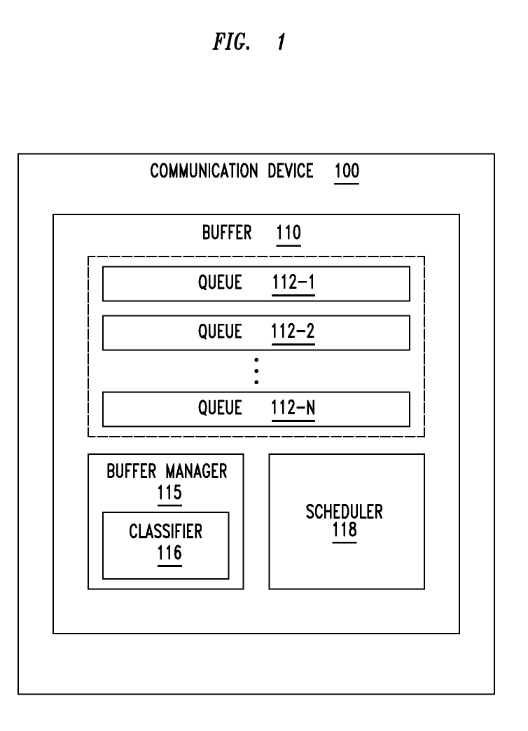

The present disclosure generally discloses a longest queue identification mechanism. The longest queue identification mechanism, for a set of queues of a buffer, may be configured to identify the longest queue of the set of queues and determine a length of the longest queue of the set of queues. The longest queue identification mechanism, for a set of queues of a buffer, may be configured to identify the longest queue of the set of queues using two variables including a longest queue identifier (LQID) variable for the identity of the longest queue and a longest queue length (LQL) variable for the length of the longest queue. It is noted that the identity of the longest queue of the set of queues may be an estimate of the identity of the longest queue (it may not always be the actual longest queue) and, similarly, that the length of the longest queue of the set of queues may be an estimate of the length of the longest queue. The longest queue identification mechanism, however, while not always identifying the actual longest queue, guarantees that the actual longest queue is identified again within not more than N−1 selection steps (N being the total number of queues) after the identity of the longest queue changes. It is noted that the longest queue identification mechanism has fixed complexity and does not require use of a complex sorting structure (e.g., a tree or other sorting structure) in order to identify the longest queue. These and various other embodiments and potential advantages of the longest queue identification mechanism may be further understood by considering the exemplary communication device of FIG. 1.

FIG. 1 depicts a communication device including a buffer configured to queue packets traversing the communication device.

The communication device 100 is configured to support packet-based communications. The communication device 100 may be a physical device or may be a virtual device implemented on physical hardware (e.g., a virtual machine (VM)). The communication device 100 may be an end device, a network device which may be deployed within a communication network (e.g., a wireline communication network, a wireless communication network, a datacenter network, an enterprise network, or the like), or the like. For example, communication device 100 may be a user device, an Internet-of-Things (IoT) device, a wireless access node, a router, a switch, or the like. In general, communication device 100 may be any type of device which may employ a buffer configured to support embodiments of buffer management as presented herein.

The communication device 100 includes a buffer 110. The buffer 110 includes a set of queues 112-1-112-N (collectively, queues 112), a buffer manager (BM) 115, and a scheduler 118.

The queues 112 are configured to temporarily store arriving packets prior to further propagation of the packets. The queues 112 may be supported using a dedicated amount of buffer memory. The queues 112 may be defined in various ways, which may depend on the context within which the buffer 110 is implemented. For example, the queues 112 may be per-link queues (e.g., for a set of input links, for a set of output links, or the like), per-flow queues, or the like. The queues 112-1-112-N have queue identifiers (QIDs) and queue lengths (QLs) associated therewith, respectively. The QLs of the queues 112 change responsive to packet events (e.g., arrivals, drops, departures, or the like).

The BM 115 is configured to manage queuing of packets in the queues 112, including handling of packets arriving at the buffer 110 (e.g., dropping of arriving packets, placement of arriving packets into the queues 112, or the like) and handling of packets stored in the queues 112 (e.g., dropping packets from queues 112, removing packets from queues 112 for further propagation from the buffer 110, or the like). The BM 115 includes a classifier 116. The classifier 116 is configured to classify arriving packets for determining placement of the arriving packets into the queues 112. The BM 115 may be configured to provide various other buffer management functions.

The scheduler 118 is a scheduler of a type that guarantees that each queue 112 with one or more stored packets is visited for service within a fixed amount of time after first receiving a packet or after last being served. For example, the scheduler 118 may be a round robin scheduler configured to service the queues 112 in sequence, extracting from each queue 112 one packet per service or packets totaling up to a fixed amount of data (e.g., measured in bytes) per service (or any other scheduler configured to provide such service guarantees). It is noted that an example of a scheduling algorithm that does not provide the service guarantees of scheduler 118 is a strict-priority scheduler that services without interruption a higher-priority queue as long as it has queued packets, without ever considering for service in the meantime any other lower-priority queues that may also have queued packets. The scheduler 118, when implemented as a round robin scheduler, may be work-conserving (e.g., it always assigns the next service opportunity to the next busy queue 112 in the schedule) or may be non-work-conserving (e.g., it assigns the next service opportunity to the next queue 112 in the schedule and, if the queue 112 is not busy, then the service opportunity is either lost or left to another scheduler to assign). The scheduler 118 may service the queue 112 by removing a packet from the front of the queue 112 (assuming that the queue 112 is not empty) and propagating the packet (e.g., toward a switching fabric, toward a network link, toward an internal component, or the like, which may depend on the context within which the buffer 110 is provided). The scheduler 118 may be configured to provide various other scheduling functions.

The BM 115 and the scheduler 118 may cooperate to provide various combinations of buffer management and scheduling functions. It will be appreciated that, depending on the context within which the buffer 110 is being used, the BM 115 may support the operation of scheduler 118 or the scheduler 118 may support the operation of the BM 115. For example, the BM 115 may support the operation of the scheduler 118 where the buffer 110 is a buffer for an input queued switch and the scheduler 118 is an RR/LQF scheduler for the input queued switch, where BM 115, with the identification of the longest queue, supports the operation of the scheduler 118. For example, the scheduler 118 may support the operation of the BM 115 where the buffer 110 is implemented such that BM 115 is a stochastic fairness queuing (SFQ) active queue management (AQM) buffer manager. It will be appreciated that the BM 115 and the scheduler 118 may cooperate in various other ways which may be used in various other contexts. It will be appreciated that, although primarily presented as separate elements within communication device 100, in at least some embodiments the BM 115 and the scheduler 118 may be implemented in other ways (which may depend on the context within which the buffer 110 is being used). In at least some embodiments, for example, where scheduler 118 supports the operation of the BM 115, the scheduler 118 may be implemented as part of BM 115. In at least some embodiments, for example, where BM 115 supports the operation of scheduler 118, the BM 115 may be implemented as part of scheduler 118. It is noted that other configurations are contemplated.

The BM 115 is configured to identify the longest queue of the set of queues 112 (which may be denoted as longest queue 1120, which includes tracking the identity of the longest queue 112_{L} of the set of queues 112 and the associated queue length of the longest queue 112_{L} of the set of queues 112 as it changes over time. It will be appreciated that the identity of the longest queue 112_{L} may change responsive to various packet events (e.g., each time a new packet arrives to the buffer 110, each time a packet stored in a queue 112 is removed from the queue 112 and propagated, and each time a packet stored in a queue 112 is discarded, or the like). The BM 115 may be configured such that only two variables need to be used to identify the longest queue 112_{L} of the set of queues 112: a longest queue identifier (LQID) variable for the identity of the longest queue 112_{L} and a longest queue length (LQL) variable for the length of the longest queue 112. The BM 115 is configured to update the LQID and LQL variables responsive to various events associated with management of queuing of packets in buffer 110, including packet arrivals to the queues 112, servicing of queues 112 by the scheduler 118, packet drops from the queues 112, or the like, as well as various combinations thereof.

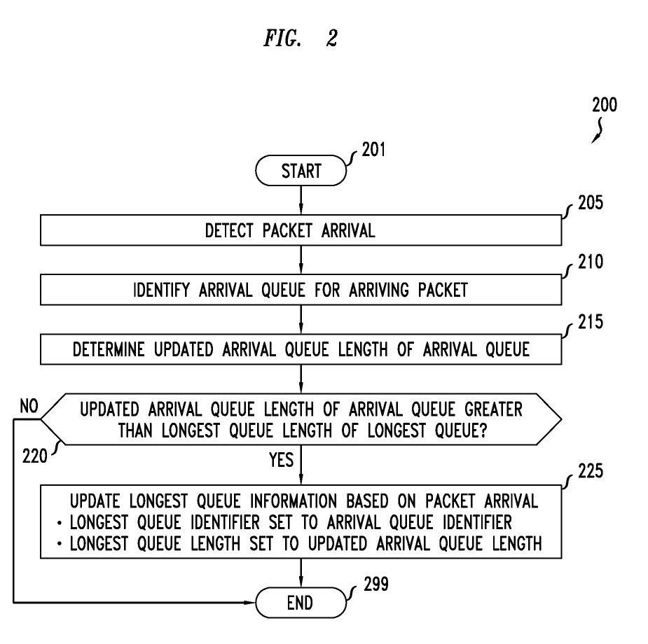

The BM 115 is configured to determine whether to update the LQID and LQL variables responsive to a packet arrival to the buffer 110. When a new packet arrives, the classifier 116 identifies one of the queues 112 with which the packet is associated (referred to as the arrival queue and denoted using arrival queue identifier (AQID)) and the arriving packet is queued in the arrival queue AQID. The BM 115 determines the queue length of the arrival queue AQID with which the packet is associated (denoted using arrival queue length (AQL)) after the arrival queue length AQL of the arrival queue AQID is updated based on the arriving packet that was queued in the arrival queue AQID (which also may be considered to be determining an updated arrival queue length AQL of the arrival queue AQID by updating the existing arrival queue length AQL of the arrival queue AQID based on the arriving packet that was queued in the arrival queue AQID). The BM 115 determines whether the arrival queue length AQL of the arrival queue AQID is greater than the longest queue length LQL of the current longest queue LQID. If the arrival queue length AQL is not greater than the longest queue length LQL of the current longest queue LQID, then the current longest queue LQID remains unchanged and, similarly, the longest queue length LQL of the current longest queue LQID also remains unchanged. If the arrival queue length AQL is greater than the longest queue length LQL of the current longest queue LQID, then the arrival queue AQID becomes the new longest queue (LQID=AQID) and the arrival queue length AQL of the arrival queue AQID becomes the new longest queue length (LQL=AQL). An exemplary embodiment of a method for handling a packet arrival is presented with respect to FIG. 2.

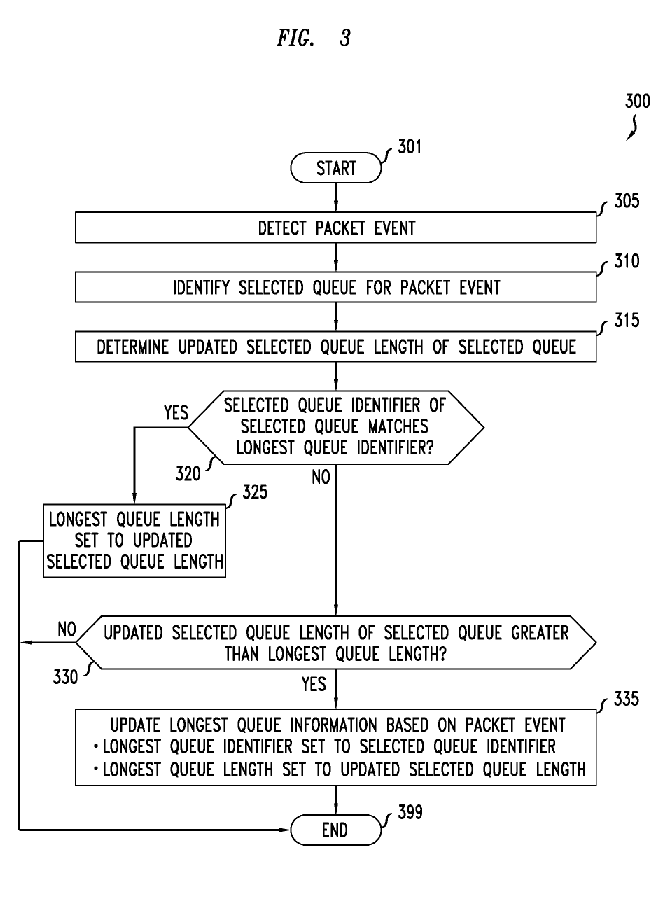

The BM 115 is configured to determine whether to update the LQID and LQL variables responsive to servicing of a queue 112 by the scheduler 118. When a queue 112 is to be serviced by the scheduler 118, the scheduler 118 identifies the next one of the queues 112 to be serviced (referred to as the serviced queue and denoted using serviced queue identifier (SQID)) and the serviced queue SQID is serviced by the scheduler 118. The scheduler 118 may service the serviced queue SQID by removing a packet from the front of the serviced queue SQID (assuming that the serviced queue SQID is not empty) and propagating the packet (e.g., toward a switching fabric, toward a network link, toward an internal component, or the like). The BM 115 determines the queue length of the serviced queue (SQID) with which the departing packet is associated (denoted using serviced queue length (SQL)) after the serviced queue length SQL of the serviced queue SQID is updated based on the departing packet that was removed from the serviced queue SQID (which also may be considered to be determining an updated serviced queue length SQL of the serviced queue SQID by updating the existing serviced queue length SQL of the serviced queue SQID based on the departing packet that was removed from the serviced queue SQID). The BM 115 determines whether the serviced queue SQID is the current longest queue LQID (which may be denoted by a determination as to whether SQID=LQID). If the serviced queue SQID is the current longest queue LQID (LQID=SQID), the longest queue LQID remains unchanged (LQID=SQID) and the serviced queue length SQL of the serviced queue SQID becomes the new longest queue length (LQL=SQL). If the serviced queue SQID is not the current longest queue LQID (LQID # SQID), the BM 115 determines whether the serviced queue length SQL of the serviced queue is greater than the longest queue length LQL of the current longest queue LQID. If the serviced queue length SQL is greater than the queue length LQL of the current longest queue LQID, then the serviced queue SQID becomes the new longest queue (LQID=SQID) and the serviced queue length SQL of the serviced queue SQID becomes the new longest queue length (LQL=SQL). If the serviced queue length SQL is not greater than the longest queue length LQL of the current longest queue LQID, then the current longest queue (LQID) remains unchanged. An exemplary embodiment of a method for handling a packet departure during servicing of a queue is presented with respect to FIG. 3.

The BM 115 is configured to determine whether to update the LQID and LQL variables responsive to dropping of a packet from a queue 112 by the scheduler 118. The condition which causes dropping of a packet from a queue 112 may depend upon the implementation of BM 115, which may in turn depend on the context within which the buffer 110 is implemented. The manner in which dropping of a packet from a queue 112 is handled in terms of determining whether to update the LQID and LQL variables also may depend on the context within which the buffer 110 is implemented.

In at least some embodiments, for example, the queue 112 from which the packet is dropped, when the buffer memory of the buffer 110 is saturated when a new packet arrives at the buffer 110, does not necessarily have to be the longest queue 112. This may be the case, for example, where the buffer 110 is implemented in an input-queued packet switch. In at least some such embodiments, for example, the operation of the BM 115 for a packet drop event, as discussed further below, may be similar to the operation of the BM 115 responsive to servicing of a queue 112 by the scheduler 118. The BM 115 determines the queue length of the drop queue (DQID) with which the dropped packet is associated (denoted using drop queue length (DQL)) after the drop queue length DQL of the drop queue DQID is updated based on the dropped packet that was removed from the drop queue DQID (which also may be considered to be determining an updated drop queue length DQL of the drop queue DQID by updating the existing drop queue length SQL of the drop queue DQID based on the dropped packet that was removed from the drop queue DQID). The BM 115 determines whether the drop queue DQID is the current longest queue LQID (which may be denoted as a determination as to whether DQID=LQID). If the drop queue DQID is the current longest queue LQID (LQID=DQID), the longest queue LQID remains unchanged (LQID=DQID) and the drop queue length DQL of the drop queue DQID becomes the new longest queue length (LQL=DQL). If the drop queue DQID is not the current longest queue LQID (LQID # DQID), the BM 115 determines whether the drop queue length DQL of the drop queue is greater than the longest queue length LQL of the current longest queue LQID. If the drop queue length DQL is greater than the longest queue length LQL of the current longest queue LQID, then the drop queue DQID becomes the new longest queue (LQID=DQID) and the drop queue length DQL of the drop queue DQID becomes the new longest queue length (LQL=DQL). If the drop queue length DQL is not greater than the longest queue length LQL of the current longest queue LQID, then the current longest queue LQID remains unchanged. An exemplary embodiment of a method for handling this type of packet drop is presented with respect to FIG. 3.

In at least some embodiments, for example, the queue 112 from which the packet is dropped, when the buffer memory of the buffer 110 is saturated when a new packet arrives at the buffer 110, is the longest queue 112_{L}. This may be the case, for example, where the buffer 110 is implemented as a stochastic fairness queuing (SFQ) active queue management (AQM) buffer manager. In at least some such embodiments, for example, the operation of the BM 115 for a packet drop event, as discussed further below, may simply include updating the drop queue length DQL of the drop queue DQID, which is the longest queue length LQL of the current longest queue LQID, based on the dropped packet. The current longest queue LQID remains unchanged.

It is noted that, where the packet drop event occurs as a result of the arrival of the packet to the buffer 110, the BM 115, after performing the longest queue identification processing for the packet drop event, performs the longest queue identification processing for the packet arrival event.

It will be appreciated that updating of queue length values may be performed in various ways, which may depend on various factors such as whether or not packet sizes are fixed or variable. In the case in which packet sizes are fixed, the queue length values may be tracked in terms of a number of packets (e.g., incremented by one (or other suitable value) for each packet arrival and decremented by one (or other suitable value) for each packet departure or drop), or number of smaller data units (e.g., bytes, bits, or the like), or the like. In the case in which packet sizes are variable, the queue length values may be tracked in terms of number of data units smaller than packets (e.g., bytes, bits, or the like), such as by increasing the queue length value by the packet size for each packet arrival and decreasing the queue length value by the packet size for each packet departure or drop), in terms of the number of packets (e.g., incremented by one (or other suitable value) for each packet arrival and decremented by one (or other suitable value) for each packet departure or drop), or the like. It will be appreciated that the queue length values may be tracked in other ways.

The BM 115 may be configured to provide various other management functions related to identifying the longest queue identifier and associated longest queue length for buffer 110.

FIG. 2 depicts an exemplary method for identifying the longest queue of a set of queues of a buffer. The method 200 of FIG. 2 is configured to identify the longest queue using a longest queue identifier (LQID) variable that maintains a value of the longest queue identifier of a queue estimated to be the longest queue and using a longest queue length (LQL) variable that maintains a value of the length of the queue estimated to be the longest queue (as indicated by the LQID). The method 200 of FIG. 2 may be performed responsive to certain events, which may include packet arrivals to the buffer or other types of packet events or conditions. It will be appreciated that, although primarily presented as being performed serially, a portion of the blocks of method 200 may be performed contemporaneously or in a different order than as presented in FIG. 2. It will be appreciated that other functions may be added to method 200, that portions of method 200 may be implemented as separate methods, or the like, as well as various combinations thereof.

At block 201, method 200 begins.

At block 205, a packet arrival is detected. Here, it is assumed that the packet event is a packet arrival; however, given that method 200 may be applied for other types of packet events, references herein to a packet arrival and an arrival queue within the context of method 200 may be read more generally as being references to a packet event and a selected queue. From block 205, method 200 proceeds to block 210.

At block 210, an arrival queue, which is one of the queues of the buffer, is identified for the arriving packet. The arrival queue is the queue into which the arriving packet is to be inserted. The arrival queue may be identified based on classification of arriving packet. The identity of the arrival queue is indicated by an arrival queue identifier (AQID) of the arrival queue. It will be appreciated that, where the buffer is full, a packet drop may be performed (from the longest queue or any other queue) in order to make room for the arriving packet. From block 210, method 200 proceeds to block 215.

At block 215, an updated arrival queue length (AQL) of the arrival queue AQID is determined. The determination of the updated arrival queue length AQL of the arrival queue AQID may include updating the existing arrival queue length AQL of the arrival queue AQID based on the arriving packet that was queued in the arrival queue AQID. The determination of the updated arrival queue length AQL of the arrival queue AQID may include sampling the arrival queue length AQL after the arrival queue length AQL has been updated based on the packet arrival. The updating of the existing arrival queue length based on the packet arrival may be denoted as [AQL=AQL+arriving packet]. From block 215, method 200 proceeds to block 220.

At block 220, a determination is made as to whether the updated arrival queue length AQL of the arrival queue AQID is greater than the longest queue length LQL of the longest queue LQID (i.e., AQL>LQL). This also may be referred to as a comparison of the updated arrival queue length AQL of the arrival queue AQID and the longest queue length LQL of the longest queue LQID.

If the updated arrival queue length AQL is not greater than the longest queue length LQL of the longest queue LQID, method 200 proceeds from block 220 to block 299 (i.e., the longest queue LQID remains unchanged and, similarly, the longest queue length LQL of the longest queue LQID also remains unchanged).

If the updated arrival queue length AQL is greater than the longest queue length LQL of the longest queue LQID, method 200 proceeds from block 220 to block 225.

At block 225, the longest queue information is updated based on the packet arrival. Namely, the longest queue identifier is set to the arrival queue identifier of the arrival queue (LQID=AQID) and the longest queue length is set to the updated arrival queue length AQL of the arrival queue AQID (LQL=AQL). The queue to which the packet arrived is now the estimate of the longest queue of the set of queues (as discussed further below, it may or may not be the actual longest queue). From block 225, method 200 proceeds to block 299.

At block 299, method 200 ends.

FIG. 3 depicts an exemplary method for identifying the longest queue of a set of queues of a buffer. The method 300 of FIG. 3 is configured to identify the longest queue using a longest queue identifier (LQID) variable that maintains a value of the longest queue identifier of a queue estimated to be the longest queue and using a longest queue length (LQL) variable that maintains a value of the length of the queue estimated to be the longest queue (as indicated by the identifier LQID). The method 300 of FIG. 3 may be performed responsive to certain events, which may include events which cause removal of packets from the queues (e.g., packet departures from the queues when the queues are serviced by a packet scheduler, packet drops from the queues when the buffer is saturated, or other types of packet events or conditions). It will be appreciated that, although primarily presented as being performed serially, a portion of the blocks of method 300 may be performed contemporaneously or in a different order than as presented in method 300 of FIG. 3. It will be appreciated that other functions may be added to method 300, that portions of method 300 may be implemented as separate methods, or the like, as well as various combinations thereof.

At block 301, method 300 begins.

At block 305, a packet event is detected. The packet event is an event which causes removal of a packet from one of the queues of the buffer (e.g., a packet departure from one of the queues when the one of the queues is serviced by a packet scheduler, a packet drop from the queue when the buffer is saturated, or the like). Accordingly, more general terms used within the context of method 300 may be modified to use more specific terms for specific types of packets events (e.g., using “packet departure” or “packet drop” rather than “packet event” as in FIG. 3, using “serviced queue” or “drop queue” rather than “selected queue” as in FIG. 3, or the like). From block 305, method 300 proceeds to block 310.

At block 310, a selected queue, which is one of the queues of the buffer, is identified for the packet event. The selected queue is the queue from which the packet is removed (e.g., retrieved and propagated, dropped, or the like). The selected queue may be identified by the scheduler (e.g., as the next queue to be serviced), by a buffer manager (e.g., as a queue from which a packet is to be dropped), or the like. The identity of the selected queue is indicated by a selected queue identifier (SQID) of the selected queue. It will be appreciated that, where the packet event is a packet drop, there may be an associated packet arrival that is causing the packet drop. From block 310, method 300 proceeds to block 315.

At block 315, an updated selected queue length (SQL) of the selected queue SQID is determined. The determination of the updated selected queue length SQL of the selected queue SQID may include updating the existing selected queue length SQL of the selected queue SQID based on the removal of the packet from the selected queue SQID. The determination of the updated selected queue length SQL of the selected queue SQID may include sampling the selected queue length SQL after the selected queue length SQL has been updated based on the packet removal. The updating of the existing selected queue length based on the packet removal may be denoted as [SQL=SQL−removed packet]. From block 315, method 300 proceeds to block 320.

At block 320, a determination is made as to whether the selected queue SQID is identified as the longest queue LQID, which may be a determination as to whether the selected queue identifier of the selected queue matches the longest queue identifier (which may be denoted as a determination as to whether SQID=LQID). If the selected queue is identified as the longest queue (SQID=LQID), method 300 proceeds from block 320 to block 325. If the selected queue is not identified as the longest queue (SQID≠LQID), method 300 proceeds from block 320 to block 330.

At block 325, the longest queue length is set to the updated selected queue length of the selected queue (LQL=SQL). Here, the longest queue identifier remains unchanged (LQID=SQID) since the selected queue SQID is already identified as the longest queue. From block 325, method 300 proceeds to block 399 (where method 300 ends).

At block 330, a determination is made as to whether the updated selected queue length SQL of the selected queue SQID is greater than the longest queue length LQL of the longest queue LQID (i.e., SQL>LQL). This also may be referred to as a comparison of the updated selected queue length SQL of the selected queue SQID and the longest queue length LQL of the longest queue LQID.

If the updated selected queue length SQL is not greater than the longest queue length LQL of the longest queue LQID, method 300 proceeds from block 330 to block 399 (i.e., the longest queue LQID remains unchanged and, similarly, the longest queue length LQL of the longest queue LQID also remains unchanged).

If the updated selected queue length SQL is greater than the longest queue length LQL of the longest queue LQID, method 300 proceeds from block 330 to block 335.

At block 335, the longest queue information is updated based on the packet event. Namely, the longest queue identifier is set to the selected queue identifier of the selected queue (LQID=SQID) and the longest queue length is set to the updated selected queue length SQL of the selected queue SQID (LQL=SQL). The queue from which the packet was removed is now the estimate of the longest queue of the set of queues (as discussed further below, it may or may not be the actual longest queue). From block 335, method 300 proceeds to block 399.

At block 399, method 300 ends.

It is noted that, within the context of FIGS. 1-3, references to the longest queue identifier (LQID) variable for the identity of the longest queue and to the longest queue length (LQL) variable for the length of the longest queue will be understood to be the values associated with those variables (i.e., the LQID value for the LQID variable and the LQL value for the LQL variable). As such, references herein to comparisons of queue identifiers with the longest queue identifier will be understood to be comparisons of the identifier values (i.e., using the current LQID value of the LQID variable) and, similarly, references herein to comparisons of queue lengths with the longest queue length will be understood to be comparisons of the length values (i.e., using the current LQL value of the LQL variable).

It is noted that the above-described processes for identifying the longest queue in a set of queues served by a round-robin scheduler are not always exact, i.e., the longest queue that is identified may not always be the actual longest queue. This may happen right after the identified longest queue is served by the scheduler, at which time the queue length of the identified longest queue is reduced (whether or not it is also the actual longest queue) such that it possibly becomes smaller than the queue length of one or more other queues; however, the identified longest queue remains the same and possibly different than the actual longest queue. While this does introduce some level of error into management of the buffer, certain considerations may justify neglecting this error associated with this occasional separation between actual longest queue and the identified longest queue.

First, the error is guaranteed to be corrected within a relatively short time. Assuming that there are N queues, and that each round-robin visit to a queue consumes a time not larger than T, the actual longest queue is guaranteed to be found again within a time (N−1)*T. In practice, the actual longest queue can be expected to be found within an even shorter time, because a long queue is indication of a high packet arrival rate, so it is likely for the actual longest queue to receive a new packet and be restored as the identified longest queue even before the next visit by the scheduler.

Second, the effect of the error on the method that uses the longest queue identification is not critical to the operation of the method and is arguably, in at least some cases, irrelevant to its performance. The reasons may be different for different queue management schemes (e.g., multi-queue AQM schemes versus input-queued switches). For example, in a multi-queue AQM scheme that drops a packet from the identified longest queue when the buffer saturates, the identified longest queue may lose multiple packets back-to-back, especially when large bursts of back-to-back packets arrive at a much higher rate than the output link rate; however, the identified target queue will never become shorter than any of the queues that hold the new incoming packets, because any other queue that becomes longer will immediately be identified as the new longest queue. For example, in a scheduler for input-queued switches that uses longest-queue first as the secondary criterion for queue selection when the candidate queue returned by the primary round robin is empty, as in RR/LQF, occasionally serving a queue that is not the actual longest queue, but has been among the longest queues in relatively recent times, does not cause major diversions from the ideal service schedule, and in any case does not take the performance of the combined scheduler below the level guaranteed by the primary RR policy. As such, while some unfairness may result from the inaccuracy in the longest queue identification, such unfairness is not sustained over time.

Various embodiments of the longest queue identification mechanism may be configured to outperform existing longest queue tracking mechanisms for identifying the longest queue of a set of queues. The least efficient method for identifying the longest queue consists of a linear search that starts as soon as the identity of the longest queue is requested (e.g., when the LQF selector controls N queues, up to N length comparisons may be needed to identify the longest queue (i.e., O(N) time complexity)). While more efficient methods for identifying the longest queue have been proposed, such methods typically require more complex data structures for keeping the queue lengths sorted after each change and their complexity typically scales logarithmically with the number of queues (i.e., O(log N) time complexity). The optimum method for finding the longest queue has a time complexity that is fixed and independent of the number of queues (i.e., O(1)). Various embodiments of the longest queue identification mechanism presented herein have fixed complexity and do not require use of a complex sorting structure in order to identify the longest queue. Various embodiments of the longest queue identification mechanism may be configured to operate a line rate even for relatively high line rates for which the time budget for execution of longest queue identification is relatively small.

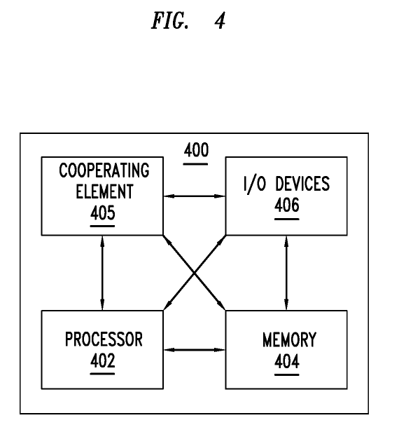

FIG. 4 depicts a high-level block diagram of a computer suitable for use in performing various functions described herein.

The computer 400 includes a processor 402 (e.g., a central processing unit (CPU), a processor having a set of processor cores, a processor core of a processor, or the like) and a memory 404 (e.g., a random access memory (RAM), a read only memory (ROM), or the like). The processor 402 and the memory 404 are communicatively connected.

The computer 400 also may include a cooperating element 405. The cooperating element 405 may be a hardware device. The cooperating element 405 may be a process that can be loaded into the memory 404 and executed by the processor 402 to implement functions as discussed herein (in which case, for example, the cooperating element 405 (including associated data structures) can be stored on a non-transitory computer-readable storage medium, such as a storage device or other storage element (e.g., a magnetic drive, an optical drive, or the like)).

The computer 400 also may include one or more input/output devices 406. The input/output devices 406 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 400 of FIG. 4 may represent a general architecture and functionality suitable for implementing functional elements described herein, portions of functional elements described herein, or the like, as well as various combinations thereof. For example, computer 400 may provide a general architecture and functionality that is suitable for implementing one or more of communication device 100, buffer 110, or the like.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
determine an updated selected queue length of a selected queue based on updating of a selected queue length of the selected queue based on a packet event;
determine whether a longest queue identifier and a selected queue identifier of the selected queue match; and
based on a determination that the longest queue identifier and the selected queue identifier of the selected queue do not match:
determine whether the updated selected queue length of the selected queue is greater than a longest queue length; and
determine, based on whether the updated selected queue length of the selected queue is greater than the longest queue length, whether to update the longest queue identifier and the longest queue length.

2. The apparatus of claim 1, wherein the processor is configured to:
based on a determination that the updated selected queue length of the selected queue is greater than the longest queue length, set the longest queue identifier to the selected queue identifier of the selected queue and set the longest queue length to the updated selected queue length of the selected queue.

3. The apparatus of claim 1, wherein the processor is configured to:
based on a determination that the updated selected queue length of the selected queue is not greater than the longest queue length, keep the longest queue identifier and the longest queue length unchanged.

4. The apparatus of claim 1, wherein the processor is configured to:
determine a second updated selected queue length of a second selected queue based on updating of a second queue length of the second selected queue based on a second packet event;
determine whether the longest queue identifier and a second selected queue identifier of the second selected queue match; and
based on a determination that the longest queue identifier and the second selected queue identifier of the second selected queue match, set the longest queue length to the second updated selected queue length of the second selected queue.

5. The apparatus of claim 1, wherein the packet event comprises a packet departure event or a packet drop event.

6. A method, comprising:
determining an updated selected queue length of a selected queue based on updating of a selected queue length of the selected queue based on a packet event;
determining whether a longest queue identifier and a selected queue identifier of the selected queue match; and
based on a determination that the longest queue identifier and the selected queue identifier of the selected queue do not match:
determining whether the updated selected queue length of the selected queue is greater than a longest queue length; and
determining, based on whether the updated selected queue length of the selected queue is greater than the longest queue length, whether to update the longest queue identifier and the longest queue length.

7. The method of claim 6, further comprising:
based on a determination that the updated selected queue length of the selected queue is greater than the longest queue length, setting the longest queue identifier to the selected queue identifier of the selected queue and setting the longest queue length to the updated selected queue length of the selected queue.

8. The method of claim 6, further comprising:
based on a determination that the updated selected queue length of the selected queue is not greater than the longest queue length, keeping the longest queue identifier and the longest queue length unchanged.

9. The method of claim 6, further comprising:
determining a second updated selected queue length of a second selected queue based on updating of a second queue length of the second selected queue based on a second packet event;
determining whether the longest queue identifier and a second selected queue identifier of the second selected queue match; and
based on a determination that the longest queue identifier and the second selected queue identifier of the second selected queue match, setting the longest queue length to the second updated selected queue length of the second selected queue.

10. The method of claim 6, wherein the packet event comprises a packet departure event or a packet drop event.

11. An apparatus, comprising:
a processor and a memory communicatively connected to the processor, the processor configured to:
determine an updated selected queue length of a selected queue based on updating of a selected queue length of the selected queue based on a packet event;
determine whether the updated selected queue length of the selected queue is greater than a longest queue length; and
based on a determination that the updated selected queue length of the selected queue is greater than the longest queue length, set a longest queue identifier to a selected queue identifier of the selected queue and set the longest queue length to the updated selected queue length of the selected queue.

12. The apparatus of claim 11, wherein the processor is configured to:
determine a second updated selected queue length of a second selected queue based on updating of a second queue length of the second selected queue based on a second packet event;
determine whether the second updated selected queue length of the second selected queue is greater than the longest queue length; and
based on a determination that the second updated selected queue length of the second selected queue is not greater than the longest queue length, keep the longest queue identifier and the longest queue length unchanged.

13. The apparatus of claim 11, wherein the processor is configured to:
determine a second updated selected queue length of a second selected queue based on updating of a second selected queue length of the second selected queue based on a second packet event;
determine whether the longest queue identifier and a second selected queue identifier of the second selected queue match; and
based on a determination that the longest queue identifier and the second selected queue identifier of the second selected queue do not match:
determine whether the second updated selected queue length of the second selected queue is greater than the longest queue length; and
determine, based on whether the second updated selected queue length of the second selected queue is greater than the longest queue length, whether to update the longest queue identifier and the longest queue length.

14. The apparatus of claim 11, wherein the packet event comprises a packet arrival event.

15. The apparatus of claim 11, wherein the packet event comprises a packet arrival event, a packet departure event, or a packet drop event.

16. A method, comprising:
determining an updated selected queue length of a selected queue based on updating of a selected queue length of the selected queue based on a packet event;
determining whether the updated selected queue length of the selected queue is greater than a longest queue length; and
based on a determination that the updated selected queue length of the selected queue is greater than the longest queue length, setting a longest queue identifier to a selected queue identifier of the selected queue and setting the longest queue length to the updated selected queue length of the selected queue.

17. The method of claim 16, further comprising:
determining a second updated selected queue length of a second selected queue based on updating of a second queue length of the second selected queue based on a second packet event;
determining whether the second updated selected queue length of the second selected queue is greater than the longest queue length; and
based on a determination that the second updated selected queue length of the second selected queue is not greater than the longest queue length, keeping the longest queue identifier and the longest queue length unchanged.

18. The method of claim 16, further comprising:
determining a second updated selected queue length of a second selected queue based on updating of a second selected queue length of the second selected queue based on a second packet event;
determining whether the longest queue identifier and a second selected queue identifier of the second selected queue match; and
based on a determination that the longest queue identifier and the second selected queue identifier of the second selected queue do not match:
determining whether the second updated selected queue length of the second selected queue is greater than the longest queue length; and
determining, based on whether the second updated selected queue length of the second selected queue is greater than the longest queue length, whether to update the longest queue identifier and the longest queue length.

19. The method of claim 16, wherein the packet event comprises a packet arrival event.

20. The method of claim 16, wherein the packet event comprises a packet arrival event, a packet departure event, or a packet drop event.
